(19) United States
(12) Patent Application Publication
(10) Pub. No.: US 2019/0093564 A1
(43) Pub. Date: Mar. 28, 2019

(54) OPTIMIZATION OF RESONATOR DESIGN BY ASSESSING IMPACT ON SYSTEM INSTABILITY

(71) Applicant: DOOSAN HEAVY INDUSTRIES & CONSTRUCTION CO., LTD., Changwon-si (KR)

(72) Inventors: Esam ABU-IRSHAID, Lake Worth, FL (US); Michael BRODY, Palm City, FL (US)

(21) Appl. No.: 15/715,652

(22) Filed: Sep. 26, 2017

(51) Int. Cl. F02C 7/24; G06F 17/50

(52) U.S. Cl. CPC F02C 7/24; G06F 2217/14; G06F 17/5009

(57) ABSTRACT

A system for designing a resonator to dampen acoustic energy in a combustion system includes a design module configured to generate a resonator design to dampen a target frequency and acceptable damping, a system analysis module configured to evaluate the resonator design within a modeled combustion system environment to determine a damping effect of the resonator design on the combustion system as a whole, and a system optimization module configured to adjust the resonator design to optimize an overall effect on the combustion system as a whole.

### BACKGROUND

Combustors, such as those used in industrial gas turbines, for example, mix compressed air with fuel and expel high temperature, high pressure gas downstream. The energy stored in the gas is then converted to work as the high temperature, high pressure gas expands in a turbine, for example, thereby turning a shaft to drive attached devices, such as an electric generator to generate electricity.

As the air/fuel mixture combusts, the hot gas that is generated creates fluctuations in pressure. These pressure fluctuations at certain frequencies (e.g., 100-5000 Hz) create acoustic pressures through the system. Accordingly, the combustion system is susceptible to High Cycle Fatigue (HCF) resulting from these combustion dynamics. The inability to account for the frequency of oscillation will jeopardize the structural integrity of the combustion system which may lead to a catastrophic failure.

There are knowns ways of preventing the excitation of natural frequency within the system. Acoustic pressure fluctuations that can generate natural frequencies may be reduced by redesigning the hardware, changing air splits, or adding external resonators to the system. However, in large applications such as an industrial gas turbine, for example, this can result in adding significant cost or reduction of the combustion system performance as extensive time for tests and modifications are needed. Additionally, if not designed properly, external resonators for this purpose can reduce the combustor performance as the resonator will need air for damping. Inefficient design and misplacement of the external resonators will take away air needed for combustion, thereby decreasing the efficiency of the combustion. Such may result in increased emission levels, metal temperature, and thermal stresses, all of which will affect the life and performance of the structure of the system.

Resonators are usually evaluated based on impedance, admittance and the amount of absorbed acoustic energy. The design of a resonator is usually based on the observed frequency. Features such as resonator volume, inner and out holes, purge air are usually adjusted to capture the desired frequency and damping. Additionally, the design of the resonator is typically performed with disregard to cooling or performance requirements.

Just as important as the design of the resonator itself, placement of the resonator within the combustion system. Typically, resonator or damper location is based on a set of criteria that is not dynamically integrated with the system. The axial or tangential placements of the resonator in the combustion system is usually based on experience or testing data. However, placing the resonator at the wrong location can impact performance and cooling of the resonator. This approach, however, may become unrealistic and costly due to extensive trial and error testing.

### BRIEF SUMMARY

The present disclosure is directed to improved resonator design and procedures for design and placement thereof based on resonator impact on the system instability rather than focusing on sets of stand-alone criteria for the resonator, optimizing the impact of the resonator on other frequencies that cannot be measured if the resonator is designed separately, thereby maximizing the resonator performance and increasing efficiency.

In one embodiment of the invention, a system for designing a resonator to dampen acoustic energy in a combustion system includes a design module configured to generate a resonator design to dampen a target frequency and acceptable damping, a system analysis module configured to evaluate the resonator design within a modeled combustion system environment to determine a damping effect of the resonator design on the combustion system as a whole, and a system optimization module configured to adjust the resonator design to optimize an overall effect on the combustion system as a whole.

In another embodiment of the invention, a computer-implemented method for damping acoustic energy in a combustion system includes the steps of designing a resonator on a computer to dampen a target frequency, analyzing the resonator on the computer to determine a damping effect of the design, evaluating the resonator within a modeled combustion system environment on the computer to determine a damping effect of the design on the combustion system as a whole, adjusting the design of the resonator on the computer to optimize an overall effect on the combustion system as a whole, and generating a finalized resonator design having the overall effect on the combustion system as a whole.

In yet another embodiment of the invention, a computer program product includes computer executable instructions that, when executed by a computer, causes the computer to perform the steps of designing a resonator on a computer to dampen a target frequency, analyzing the resonator on the computer to determine a damping effect of the design, evaluating the resonator within a modeled combustion system environment on the computer to determine a damping effect of the design on the combustion system as a whole, adjusting the design of the resonator on the computer to optimize an overall effect on the combustion system as a whole, and generating a finalized resonator design having the overall effect on the combustion system as a whole.

### BRIEF DESCRIPTION OF DRAWINGS

FIGS. 1A and 1B are conceptual diagrams according to exemplary embodiments.

FIG. 2 is a flow diagram of the design procedure according to an exemplary embodiment.

FIG. 3 is a diagram showing results of optimization according to an exemplary embodiment.

FIG. 4 is a block diagram of a design system according to an exemplary embodiment.

### DETAILED DESCRIPTION

Various embodiments of an acoustic resonator in a combustion system and a method of designing the same are described. It is to be understood, however, that the following explanation is merely exemplary in describing the devices and methods of the present disclosure. Accordingly, any number of reasonable and foreseeable modifications, changes, and/or substitutions are contemplated without departing from the spirit and scope of the present disclosure.

Resonator or damper location in combustion systems has typically been based on a set of criteria that is not dynamically integrated with the system. Axial or tangential locations of the resonator depends on experience with combustion systems and testing data. Placing the resonator at the wrong location can impact performance and cooling of the resonator.

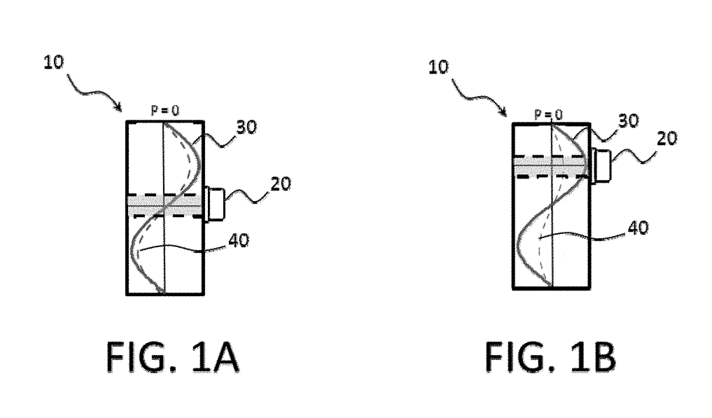

FIG. 1A is a conceptual diagram of a combustion system 10 with a resonator 20. Industrial standard method for designing a resonator focuses on adjusting the resonator frequency and damping effect for the targeted frequency without regard to the resonator environment, such as the combustion system, turbine exhaust, or compressor. The result is as shown in FIG. 1A where a longitudinal acoustic wave 30 is generated in the combustion system 10 causing vibrations and other structural stress on the system. While the resonator 20 may have been designed based on frequency of the longitudinal acoustic wave 30 to dampen its effects, resonator 20 is placed near a node. The result is that the damping effect is minimal as shown by damped mode 40, or worse yet, the resonator 20 may actually end up introducing acoustic energies that may adversely impact the combustion system 10 when considered as a whole.

FIG. 1B is a conceptual diagram of a combustion system 10 with a resonator 20 in accordance with exemplary embodiments disclosed herein. As described, resonator design is evaluated in conjunction with the system in which unstable frequency is targeted and allows optimization of the resonator location, axially or tangentially, so that maximum damping with minimum impact on system performance can be achieved. For example, determining the location of an anti-node of the targeted wave allows the placement of a resonator directly on or very close to the anti-node, thereby reducing the amount of required purged air and thus improve performance. By integrating the resonator design with system instability model, resonator 20 is placed on or near the anti-node of the longitudinal acoustic wave 30 such that damping is maximized as shown by damped mode 40, thereby resulting in reduced cost and improved cooling.

External resonators are expensive and can cause inefficiencies when air goes through the resonator rather than through the combustion system, thereby increasing emissions. Further, cold air mixing with hot gas causes thermal stresses, thereby weakening the structural integrity of the components in the combustion system. In accordance with the present disclosure, resonators are placed on the outside of the combustion system by forming holes in the liner. By considering the size and shape of the holes, the amount of airflow, and shell volume, a resonator is created to dampen a target frequency without affecting the emissions efficiencies of the combustion system.

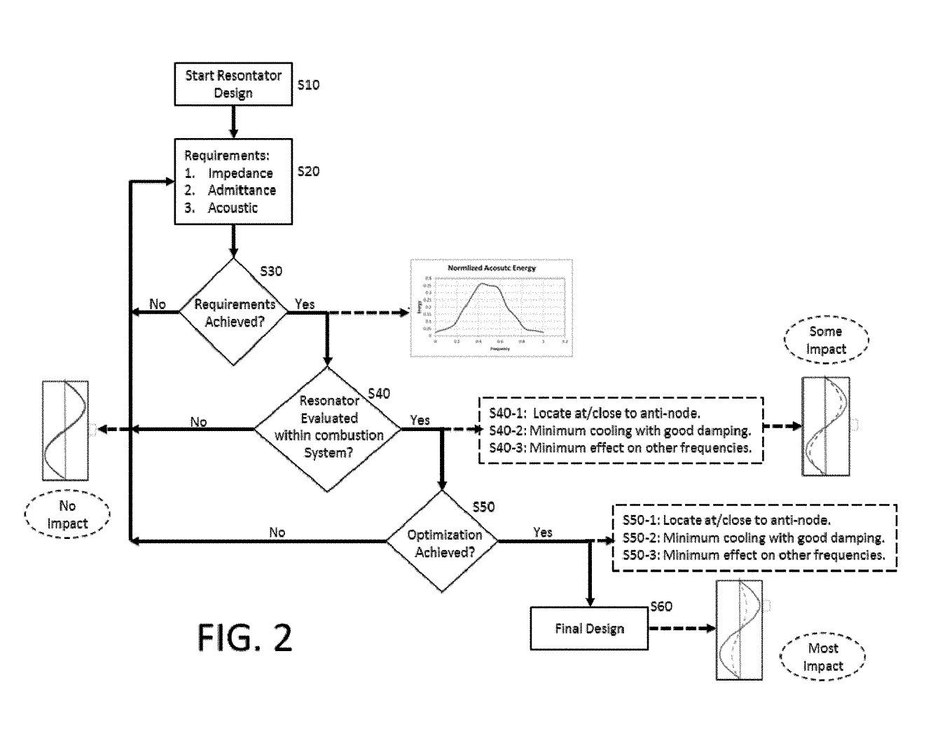

FIG. 2 is a flow diagram of the design procedure according to an exemplary embodiment. The process begins with the step of designing the resonator (S10). The impedance, admittance, and acoustic characteristics of the resonator is considered based on the target frequency to be dampened (S20). The resonator design is tested in a simulator, for example, to determine if the requirements have been achieved (S30). Once the resonator design is confirmed to meet the performance requirements, such as the target frequency to be damped, the resonator is further evaluated within combustion system environment (S40).

The acoustic model for the whole combustion system in accordance with the present disclosure gives expected frequencies. In particular, frequency plot of the combustion system is used to identify a frequency with unstable energy and a mode for that frequency is plotted to identify the anti-node type and location (S40-1). The resonator design is then placed at or near the identified anti-node and evaluated for damping effect with minimum cooling requirements (S40-2). The entire combustion system with the resonator design in place is then evaluated for effects on other frequencies in the system (S40-3).

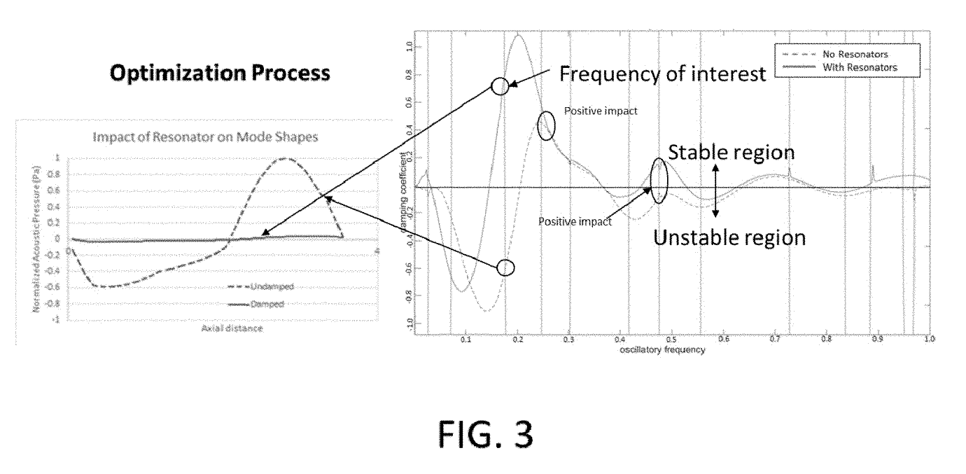

Once a resonator design and placement of the resonator in the combustion system has been evaluated, the design and placement of the resonator is evaluated for optimization (S50). For example, placement of the resonator may be adjusted to provide slightly less damping for the sake of increasing the effect on cooling by re-evaluating the location of the anti-node (S50-1), effects of cooling (S50-2), and effects on other frequencies (S50-3). Once all evaluations have been performed, the design and placement of the resonator is finalized (S60). The effects of the optimization according to the present disclosure is illustrated in FIG. 3. As shown, the targeted frequency (i.e., the frequency of interest) is pulled into the stable region with minimum impact on other frequencies.

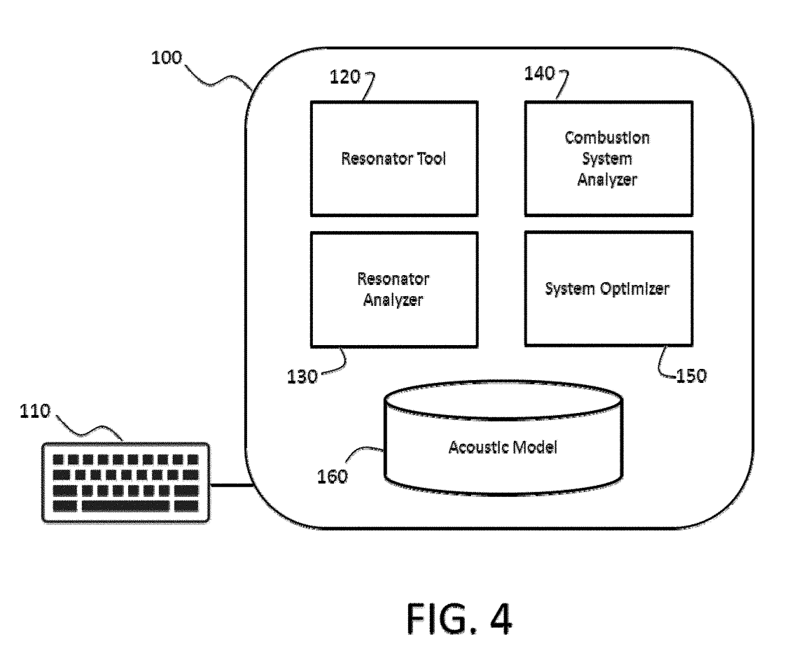

FIG. 4 is a block diagram of a resonator design system (“RDS”) according to an exemplary embodiment. RDS 100 includes an input device 110, a resonator tool module 120, resonator analysis module 130, combustion system analysis module 140, and system optimization module 150. The resonator tool module 120 is responsible for accepting the desired operating parameters of a resonator under design, such as, for example, impedance, admittance, acoustic frequencies, and the like, and the associated physical characteristics, such shape, size, and volume of the resonator, and the like, and creating an acoustic model of the resonator. The resonator analysis module 130 is responsible for simulating the performance of the designed resonator and analyzing the expected operational characteristics of the resonator under design based on the acoustic model generated from the input parameters. The combustion system analysis module 140 is responsible for simulating the performance of the designed resonator within the combustion system environment, including identification of the node and anti-node locations of the targeted frequencies for damping based on the frequency plot of the unstable energy generated within the combustion system, to evaluate the effect of the designed resonator on the operational characteristics of the combustion system as a whole. The system optimization module 150 is responsible for optimizing not only the individual operating parameters of the resonator under design, but also to optimize the location and its effects on the combustion system as a whole such that some efficiencies of the resonator may be sacrificed for the benefit of the performance of the entire combustion system as a whole.

The acoustic model 160 provides the foundation for each of the resonator tool module 120, the resonator analysis module 130, the combustion system analysis module 140, and the system optimization module 150 to be able to perform the necessary design and analyses. In particular, the acoustic model 160 includes models of the mode shape of the acoustic energies and frequencies that are generated within the combustion system, models of the damping effects of the resonator, and models of the resonator and combustion system components, such as heat source, heat transfer characteristics, friction/damping effects, etc. For example, the acoustic model 160 includes mathematical modeling of the damping impact or effect of the resonator on the combustion system as a whole rather than as a stand-alone design, as shown in Equation (1) below:

$$damping = ( \underbrace{\overline{ρ} {\overline{u}}_{hole}}_{flow terem} + \underbrace{\overline{ρ} \overline{c} \frac{1}{8} {( \frac{ω}{\overline{c}} {d}_{hole} )}^{2}}_{= radiation tearm} + \underbrace{\frac{1}{2} \overline{ρ} k {u}^{′}}_{non linear tearm} + viscous dissipation term ) \\ \overline{ρ} \text{:} fluid density \\ \overline{c} \text{:} speed of sound \\ k \text{:} loss factor \\ {u}^{′} \text{:} acoustic velocity \\ ω \text{:} radial frequency \qquad ( Eq . 1 )$$

Additionally, the damping model above employs non-linear effects that account for saturation such that saturation is predicted to prevent resonator over-damping.

By modeling both the driving or energy source and the damping source, the combustion system analysis module 140 can determine whether the resonator would effectively dampen the targeted acoustic energy, have no significant effect, or make the combustion system even more unstable. Based on the acoustic models generated within the combustion system, the overall impact of the design resonator is assessed and optimization is achieved quickly and cost efficiently, reducing testing time from trial and error approaches used in the past.

Some of the advantages of the exemplary embodiments include: reduced testing cost related to optimization of the resonator location, reduced testing cost by optimizing the inner and outer hole sizes of the resonator, reduced uncertainty of the resonator design as it is assessed on the direct impact against the instability of the combustion system rather than on stand-alone criteria, and optimization of the resonator location, axially or tangentially, so as to achieve maximum damping with minimum impact of system performance.

The breadth and scope of the present disclosure should not be limited by any of the above-described exemplary embodiments, but should be defined only in accordance with the following claims and their equivalents. For example, each of the modules in the RDS 100 may be stand-alone software applications or one or more module may be combined. Further, RDS 100 may be implemented on a general purpose computer, or on a specialized device, and may be stand-alone or networked to take advantage of distributed processing on multiple computers. Moreover, the above advantages and features are provided in described embodiments, but shall not limit the application of the claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Further, a description of a technology in the “Background” is not to be construed as an admission that technology is prior art to any invention(s) in this disclosure. Neither is the “Brief Summary” to be considered as a characterization of the invention(s) set forth in the claims found herein. Furthermore, any reference in this disclosure to “invention” in the singular should not be used to argue that there is only a single point of novelty claimed in this disclosure. Multiple inventions may be set forth according to the limitations of the multiple claims associated with this disclosure, and the claims accordingly define the invention(s), and their equivalents, that are protected thereby. In all instances, the scope of the claims shall be considered on their own merits in light of the specification, but should not be constrained by the headings set forth herein.

What is claimed is:

1. A system for designing a resonator to dampen acoustic energy in a combustion system, comprising:
a design module configured to generate a resonator design to dampen a target frequency and acceptable damping;
a system analysis module configured to evaluate the resonator design within a modeled combustion system environment to determine a damping effect of the resonator design on the combustion system as a whole; and
a system optimization module configured to adjust the resonator design to optimize an overall effect on the combustion system as a whole.

2. The system of claim 1, wherein the resonator design includes impedance, admittance, and acoustic characteristics based on the target frequency.

3. The system of claim 1, wherein the system analysis module is further configured to determine a location of an anti-node of the target frequency in the combustion system.

4. The system of claim 3, wherein the system analysis module is further configured to assess a damping effect of the damper design at the location of the anti-node of the target frequency.

5. The system of claim 4, wherein the system analysis module is further configured to determine whether the resonator design dampens the target frequency, has no effect on the target frequency, or worsens stability of the combustion system as a whole.

6. The system of claim 1, wherein the system optimization module is further configured to adjust a location of the resonator design in the combustion system based the overall effect, the overall effect including effects of cooling the combustion system and effects on frequencies other than the target frequency in the combustion system.

7. The system of claim 1, wherein the modeled combustion system environment includes non-linear effects accounting for saturation.

8. A computer-implemented method for damping acoustic energy in a combustion system, the method comprising the steps of:
designing a resonator on a computer to dampen a target frequency;
analyzing the resonator on the computer to determine a damping effect of the design;
evaluating the resonator within a modeled combustion system environment on the computer to determine a damping effect of the design on the combustion system as a whole;
adjusting the design of the resonator on the computer to optimize an overall effect on the combustion system as a whole; and
generating a finalized resonator design having the overall effect on the combustion system as a whole.

9. The computer-implemented method of claim 8, wherein the step of evaluating the resonator within the modeled combustion system environment includes impedance, admittance, and acoustic characteristics of the resonator based on the target frequency.

10. The computer-implemented method of claim 8, wherein the step of evaluating the resonator within the modeled combustion system environment includes determining a location of an anti-node of the target frequency in the combustion system.

11. The computer-implemented method of claim 10, wherein the step of evaluating the resonator within the modeled combustion system environment includes assessing a damping effect of the design at the location of the anti-node of the target frequency.

12. The computer-implemented method of claim 11, wherein the step of evaluating the resonator within the modeled combustion system environment includes determining whether the design dampens the target frequency, has no effect on the target frequency, or worsens stability of the combustion system as a whole.

13. The computer-implemented method of claim 8, wherein the step of adjusting the design of the resonator includes adjusting a location of the resonator in the combustion system based the overall effect, the overall effect including effects of cooling the combustion system and effects on frequencies other than the target frequency in the combustion system.

14. The computer-implemented method of claim 8, wherein the modeled combustion system environment includes non-linear effects accounting for saturation.

15. A computer program product comprising computer executable instructions that, when executed by a computer, causes the computer to perform the steps of:
designing a resonator on a computer to dampen a target frequency;
analyzing the resonator on the computer to determine a damping effect of the design;
evaluating the resonator within a modeled combustion system environment on the computer to determine a damping effect of the design on the combustion system as a whole;
adjusting the design of the resonator on the computer to optimize an overall effect on the combustion system as a whole; and
generating a finalized resonator design having the overall effect on the combustion system as a whole.

16. The computer-implemented method of claim 15, wherein the step of evaluating the resonator within the modeled combustion system environment includes determining a location of an anti-node of the target frequency in the combustion system.

17. The computer-implemented method of claim 16, wherein the step of evaluating the resonator within the modeled combustion system environment includes assessing a damping effect of the design at the location of the anti-node of the target frequency.

18. The computer-implemented method of claim 17, wherein the step of evaluating the resonator within the modeled combustion system environment includes determining whether the design dampens the target frequency, has no effect on the target frequency, or worsens stability of the combustion system as a whole.

19. The computer-implemented method of claim 15, wherein the step of adjusting the design of the resonator includes adjusting a location of the resonator in the combustion system based the overall effect, the overall effect including effects of cooling the combustion system and effects on frequencies other than the target frequency in the combustion system.

20. The computer-implemented method of claim 15, wherein the modeled combustion system environment includes non-linear effects accounting for saturation.
